(19) United States
(12) Patent Application Publication
(10) Pub. No.: US 2026/0180239 A1
(43) Pub. Date: Jun. 25, 2026

(54) Electrical Connector

(71) Applicant: ADB Safegate Americas, LLC, Gahanna, OH (US)

(72) Inventor: Harmanjit S. DHILLON, Cambridge (CA)

(73) Assignee: ADB Safegate Americas, LLC, Gahanna, OH (US)

(21) Appl. No.: 19/124,289

(22) PCT Filed: Oct. 31, 2022
(86) PCT No.: PCT/US2022/048425

§ 371 Date: Apr. 24, 2025

(51) Int. Cl. H01R 13/52; H01R 13/512; H01R 13/622; H01R 13/627; H01R 13/631; H01R 13/639; H01R 13/648; H01R 13/6581

(52) U.S. Cl. CPC H01R 13/5205; H01R 13/512; H01R 13/5202; H01R 13/5219; H01R 13/622; H01R 13/6275; H01R 13/631; H01R 13/639; H01R 13/648; H01R 13/6581

(57) ABSTRACT

Disclosed herein are parts of an electrical connector that are suitable for direct earth burial, submergence in water, and capable of withstanding limited exposure to chemicals typically present on an airfield, including but not limited to, oil, de-icing fluids, and/or gasoline. In one embodiment, there is disclosed a plug that has one or more ribbed surfaces where the plug interfaces with a receptacle that may or may not have ribbed surfaces. In another embodiment, there is disclosed a receptacle that has one or more ribbed surfaces where the receptacle interfaces with a plug that may or may not have ribbed surfaces. In yet another embodiment, there is disclosed a cable shield boot housing that can be employed with either the plug or receptacle.

### TECHNICAL FIELD

The present disclosure relates generally to a an electrical connector and/or a plug, a receptacle, or a combination of a plug and receptacle (cable connector) useful for airfield lighting applications such as, for example, underground power cables, isolation transformer leads, and/or light fixture leads for airport lighting systems.

### BACKGROUND

Many aeronautical ground lighting systems employ an underground cable coupled with a power source to provide power to a light fixture. An isolation transformer is disposed between the underground cable and the light fixture. Electrical connectors, e.g., a receptacle (or socket) and a plug are employed to connect the isolation transformer's primary coil to the underground cable. Because the connection of the underground cable to the transformer is underground, this connection should be suitable for direct earth burial, submergence in water, and capable of withstanding limited exposure to chemicals typically present on an airfield, including but not limited to, oil, de-icing fluids, and/or gasoline.

The Federal Aviation Administration (FAA) in Advisory Circular (AC) AC 150/5345-26 (currently revision E) contains requirements for plug and receptacle (cable connectors) to be used for underground connections for power cables, isolation transformer leads, and light fixture leads for airport systems. The aforementioned Advisory Circular includes environmental and performance requirements.

### SUMMARY OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein a plug comprising a housing that comprises a first end and a second end. The first end comprises a bore configured to receive a cable. The second end having a first plug vertical surface, a plug horizontal surface extending from the first plug vertical surface, and a second plug vertical surface extending from an opposite end of the plug horizontal surface. The first plug vertical surface, plug horizontal surface, and second plug vertical surface are configured to abut with surfaces of a receptacle. One surface selected from the group consisting of the first plug vertical surface, the plug horizontal surface, and the second plug vertical surface comprises at least one rib.

In accordance with an example embodiment, there is disclosed herein a receptacle comprising a receptacle housing that comprises a first end and a second end. The first end comprises a bore configured to receive a cable. The second end having a first receptacle vertical surface, a receptacle horizontal surface extending into the receptacle housing from the first receptacle vertical surface, and a second receptacle vertical surface extending from an opposite end of the receptacle horizontal surface. The first receptacle vertical surface, receptacle horizontal surface, and second receptacle vertical surface are configured to be coupled with a receptacle. A surface selected from the group consisting of the first receptacle vertical surface, the receptacle horizontal surface, and the second receptacle vertical surface comprises at least one rib.

In accordance with an example embodiment, there is disclosed herein a connector kit that comprises a plug and a receptacle. The plug comprises a plug housing that comprises a first end and a second end. The first end comprises a bore configured to receive a first cable coupled with a pin contact assembly and the second end having a first plug vertical surface, a plug horizontal surface extending from the first plug vertical surface, and a second plug vertical surface extending from an opposite end of the plug horizontal surface.

The receptacle comprises a receptacle housing that comprises a first end and a second end. The first end comprises a bore configured to receive a second cable coupled with a socket contact assembly. The second end having a first receptacle vertical surface, a receptacle horizontal surface extending into the receptacle housing from the first receptacle vertical surface, and a second receptacle vertical surface extending from an opposite end of the receptacle horizontal surface;

When the plug and receptacle are coupled, the pin contact assembly contacts the socket contact assembly forming an electrical connection between the first cable and the second cable. Also, when the plug and receptacle are coupled, the first plug vertical surfaces abuts the first receptacle vertical surface, the plug horizontal surface abuts the receptacle horizontal surface, and the second plug vertical surface abuts the second receptacle vertical surface receptacle. A surface selected from the group consisting of the first plug vertical surface, the first receptacle vertical surface, the plug horizontal surface, the receptacle horizontal surface, the second plug vertical surface, and the second receptable vertical surface comprises at least one rib.

In accordance with an example embodiment, there is disclosed herein a cable shield boot housing that comprises a housing with first and second ends where a cable port is at a first end of the housing and a flap extends from the second end of the housing. A shield connector is port located near the first end of the housing. A shield ribbed seal is located in the shield connector port. A cable ribbed seal is located in the cable port. A ribbed housing seal is located at the second end of the housing.

### BRIEF DESCRIPTION OF THE DRAWINGS

The accompanying drawings incorporated herein and forming a part of the specification illustrate the example embodiments.

FIG. 1 illustrates an example of a cutaway view of a plug with a flap in the unfolded position.

FIG. 2 illustrates an example of a cutaway view of a plug in FIG. 1 with the flap in the folded position.

FIG. 3 illustrates an example of a cable with a pin contact assembly mounted thereon suitable for use with the plug illustrated in FIGS. 1 and 2.

FIG. 4 illustrates an example of a cutaway view of the plug illustrated in FIG. 2 attached to the cable illustrated in FIG. 3.

FIG. 5 illustrates an example of a cutaway view of a receptacle with a flap in the unfolded position.

FIG. 6 illustrates an example of a cable with a socket contact assembly mounted thereon suitable for use with the receptacle illustrated in FIG. 5.

FIG. 7 illustrates an example of a cutaway view of the receptacle illustrated in FIG. 5 with the flaps folded back and mounted on the cable illustrated in FIG. 6.

FIG. 8 illustrates an example cutaway view of a plug coupled with a receptacle with the flaps folded.

FIG. 9 illustrates an example cutaway view of a plug coupled with a receptacle with the flaps engaged.

FIG. 10 illustrates an example cutaway view of a cable shield boot housing.

FIG. 11 illustrates an example cutaway view of a shielded cable suitable for use with the cable shield boot housing described in FIG. 10.

FIG. 12 illustrates an example of a cross sectional view of the shielded cable described in FIG. 11.

FIG. 13 illustrates an example of a the shielded cable described in FIGS. 11 and 12 with a shield ring coupled with a shield conductor and the outer conductor of the shielded conductor.

FIG. 14 illustrates an example cutaway view of a plug coupled with a shielded cable and a shielded boot housing.

FIG. 15 illustrates of an example cutaway view of a receptacle coupled with a shielded cable and a shielded boot housing.

FIG. 16 illustrates an example cutaway view of a plug coupled with a receptacle for a shielded cable with a shielded boot housing.

FIG. 17 illustrates an example cutaway view of an airfield light system that employs an isolation transformer that is coupled with shielded cables and an airfield luminaire with the plugs and receptacles unattached.

FIG. 18 illustrates an example cutaway view of an airfield light system that employs an isolation transformer that is coupled with shielded cables and an airfield luminaire with the plugs and receptacles attached.

FIG. 19 illustrates an example cutaway view of an airfield light system that employs an isolation transformer that is coupled with unshielded cables and an airfield luminaire with the plugs and receptacles unattached.

FIG. 20 illustrates an example cutaway view of an airfield light system that employs an isolation transformer that is coupled with unshielded cables and an airfield luminaire with the plugs and receptacles attached.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Disclosed herein are parts of an electrical connector that are suitable for direct earth burial, submergence in water, and capable of withstanding limited exposure to chemicals typically present on an airfield, including but not limited to, oil, de-icing fluids, and/or gasoline. In one embodiment, there is described a plug that has one or more ribbed surfaces where the plug interfaces with a receptacle that may or may not have ribbed surfaces. In another embodiment, there is described a receptacle that has one or more ribbed surfaces where the receptacle interfaces with a plug that may or may not have ribbed surfaces. In yet another embodiment, a cable shield boot housing that can be employed with either the plug or receptacle.

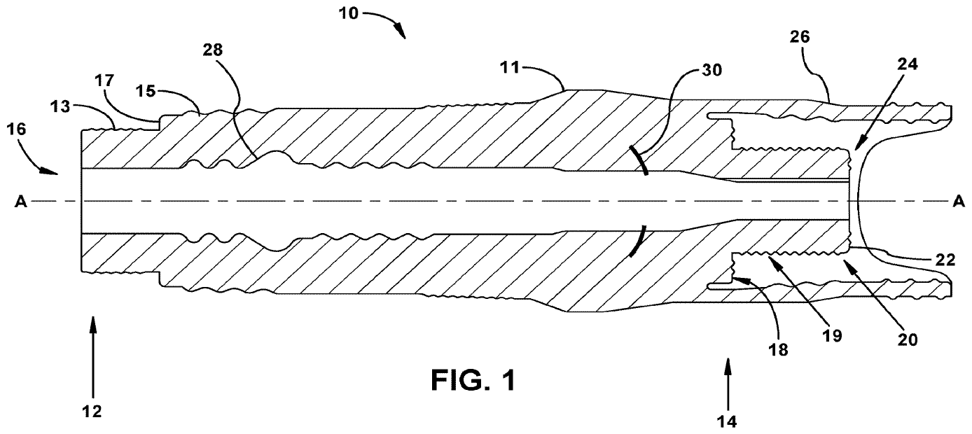

FIG. 1 illustrates an example of a cutaway view of a plug 10. In the examples illustrated herein, the plug 10 is substantially cylindrical but those skilled in the art can readily appreciate that the principles described herein are adaptable to other three dimensional shapes so the example embodiments described herein should not be construed as limited to cylindrical structures. The plug 10 comprises a plug housing 11 with an unfolded flap 26. The plug housing 11 comprises a first end 12 and a second end 14.

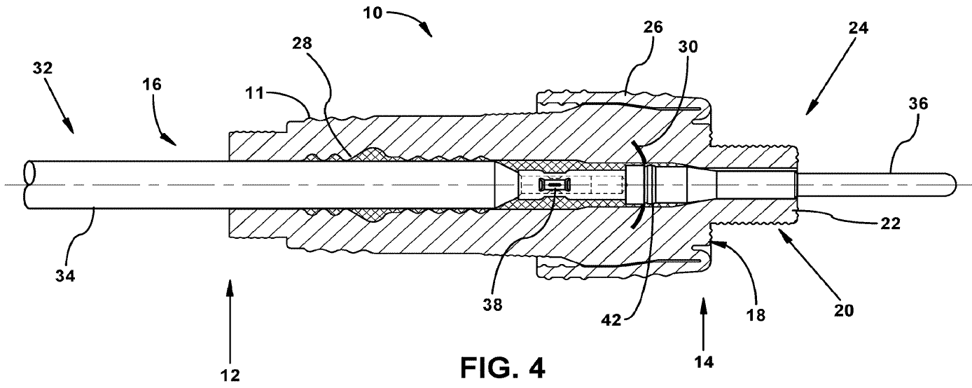

In an example embodiment, the plug housing 11 is molded from natural and/or synthetic elastomeric materials serving both as insulation and sheath to fully enclose a portion of the pin (not shown, see e.g., FIG. 4) of the plug. In an example embodiment, the housing material is suitable for direct earth burial, submergence in water, and capable of withstanding limited attack from chemicals, typically present on the airfield, including but not limited to, oil, de-icing fluids and/or gasoline. In particular embodiments, the plug housing 11 is fabricated from materials capable of bonding to cable sheaths or conductor insulation, during the manufacturing process, to provide a watertight bond.

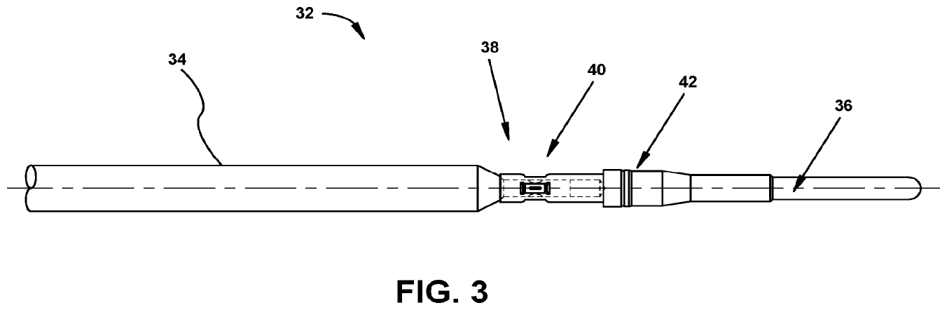

The first end 12 comprises a bore 16 configured to receive a cable (not shown, see e.g., FIGS. 3, 4 infra) along the longitudinal axis A-A of the plug housing 11. The second end 14 has a first plug vertical surface 18, a plug horizontal surface 20 extending from the first plug vertical surface 18, and a second plug vertical surface 22 extending from an opposite end 24 (the end opposite where the plug horizontal surface 20 meets with the first plug vertical surface 18) of the plug horizontal surface 20.

In an example embodiment one of the first plug vertical surface 18, plug horizontal surface 20, and second plug vertical surface 22 comprise at least one, rib. The rib provide a seal with a receptacle (not shown, see e.g., FIG. 4 infra) when the plug 10 is coupled with the receptacle. In an example embodiment, the first plug vertical surface 18 comprises at least one rib 19. In another example embodiment the plug horizontal surface 20 comprises at least one rib 19. In yet another example embodiment, the second plug vertical surface 22 comprises at least one rib 19.

In an example embodiment, two of the surfaces selected from the first plug vertical surface 18, the plug horizontal surface 20, and the second plug vertical surface 22 comprise at least one rib 19. For example, in one embodiment, the first plug vertical surface 18 and the plug horizontal surface 20, comprise at least one rib 19. As another example, the plug horizontal surface 20, and the second plug vertical surface 22 comprise at least one rib 19. In yet another example, the first plug vertical surface 18, and the second plug vertical surface 22 comprise at least one rib 19. In still yet another example embodiment, the first plug vertical surface 18, the plug horizontal surface 20, and the second plug vertical surface 22 have ribbed surfaces.

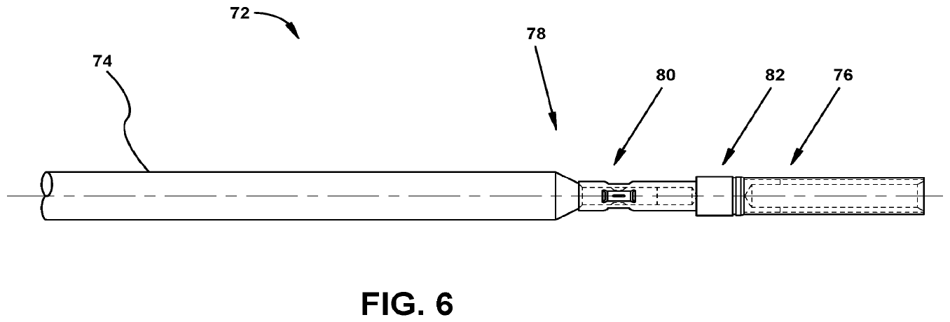

The flap 26 when extended outward as illustrated in FIG. 1 has a length sufficient to extend over a designed ridge on a receptacle to form a watertight seal preventing water from reaching the pin contact assembly (not shown, see e.g., ref. 36 in FIGS. 3,4) and/or the socket contact assembly (not shown, see e.g., ref. 76 in FIGS. 6,7).

In an example embodiment, the plug housing 11 further comprises a cable ribbed seal 28 near the first end 12 of the plug housing 11. The cable ribbed seal 28 comprises at least one rib and is employed to prevent water or other contaminants from reaching the pin connector from the first end 12.

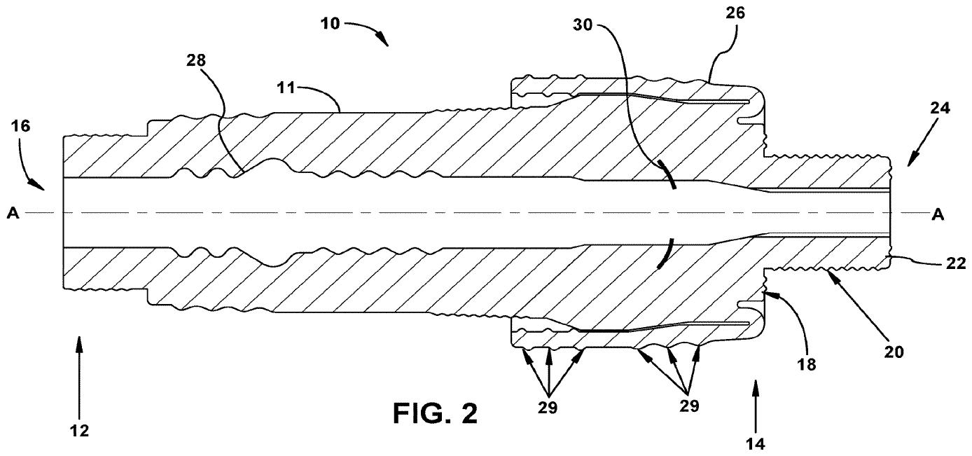

In an example embodiment, the plug housing 11 comprises a lock washer 30 that is molded into the housing. As will be described herein infra, the lock washer 30 can be employed to engage and hold the conductor. FIG. 2 illustrates an example of a cutaway view of a plug housing 11 with the flap 26 in the folded position. In particular embodiments, the flap 26 comprises at least one rib 29 which can form a seal when the flaps 26 are extended when the plug 10 is coupled with a receptacle. When the plug 10 is coupled with a receptacle, the surface of the receptacle that abut surfaces 18 can be either smooth or ribbed, the surface of the receptacle that abuts surface 20 can either be smooth or ribbed, and the surface of the plug that abuts surface 22 can either be smooth or ribbed.

In an example embodiment, the first end 12 of the housing 11 has a first surface 13 and a second surface 15. The first surface 15 and second surface 17 are separated by a vertical surface 17.

FIG. 3 illustrates an example of a cable 32 with a pin contact assembly 36 attached thereto suitable for use with the plug housings illustrated in FIGS. 1 and 2, which is illustrated in FIG. 4. The cable 32 comprises insulation 34 that passes through bore 16. The end 38 of the cable 32 where the pin contact assembly 36 is mounted is stripped of insulation 34. A crimp connection 40 is employed to attach the pin contact assembly 36 onto the stripped end 38 of the cable 32. As will be described herein infra, the pin contact assembly 36 comprises a lock ring 42 configured to engage the lock washer 30 of plug housing 11.

FIG. 4 illustrates an example of a cutaway view of the plug housing 11 as illustrated in FIG. 2 attached to the cable illustrated in FIG. 3. The cable ribbed seal 28 engages the insulation 34 of cable 30 and forms a barrier against water or other contaminants. The lock washer 30 engages the lock ring 42 to hold the plug housing 11 onto the cable 32. When the plug 10 is coupled with a receptacle, surfaces 18, 20, and 22 abut surfaces of the receptacle and prevent water and other contaminants from reaching pin 36. As described herein, supra, one or more of surfaces 18, 20, and 22 are ribbed.

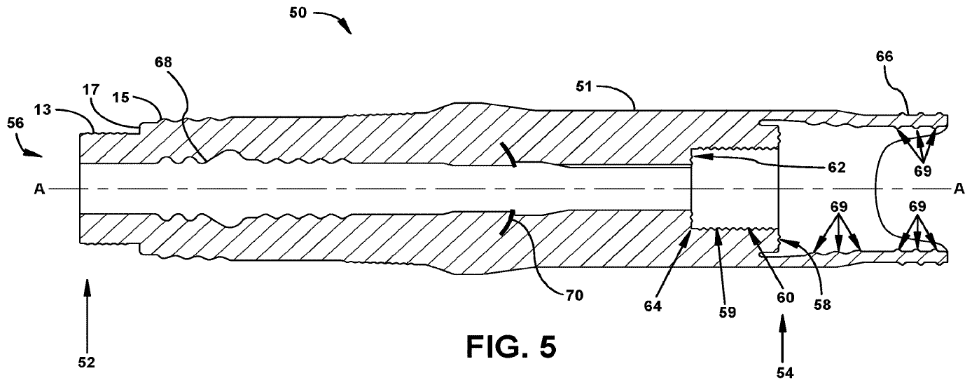

FIG. 5 illustrates an example of a cutaway view of a receptacle 50. In the examples illustrated herein, the receptacle 50 is substantially cylindrical but those skilled in the art can readily appreciate that the principles described herein are adaptable to other three dimensional shapes so the example embodiments described herein should not be construed as limited to cylindrical structures. The receptacle comprises a housing 51 with a flap 66 in the unfolded position. The receptacle housing 51 comprises a first end 52 and a second end 54.

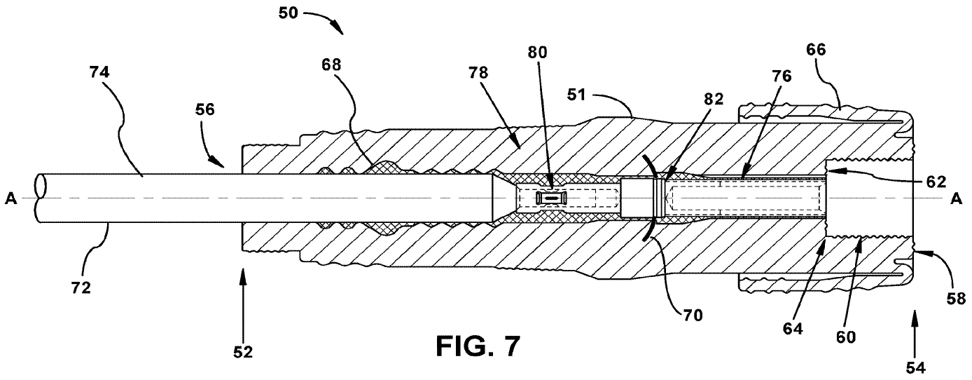

In an example embodiment, the receptacle housing 50 is molded from natural and/or synthetic elastomeric materials serving both as insulation and sheath to fully enclose the socket contact (not shown, see e.g., FIG. 7) of the receptacle. The housing material must be suitable for direct earth burial, submergence in water, and capable of withstanding limited attack from chemicals, typically present on the airfield, including but not limited to, oil, de-icing fluids and/or gasoline. In particular embodiments, the receptacle housing 51 is fabricated from materials capable of bonding to cable sheaths or conductor insulation, during the manufacturing process, to provide a watertight bond.

The first end 52 comprises a bore 56 configured to receive a cable (not shown, see e.g., FIG. 7, infra) along the longitudinal axis A-A of the receptacle housing 51. The second end 54 has a first receptacle vertical surface 58, a receptacle horizontal surface 60 extending into the receptacle housing 50 from the first receptacle vertical surface 58, and a second receptacle vertical surface 62 extending from an opposite end 64 (the end opposite where the receptacle horizontal surface 60 meets with the first receptacle vertical surface 58) of the receptacle horizontal surface 60.

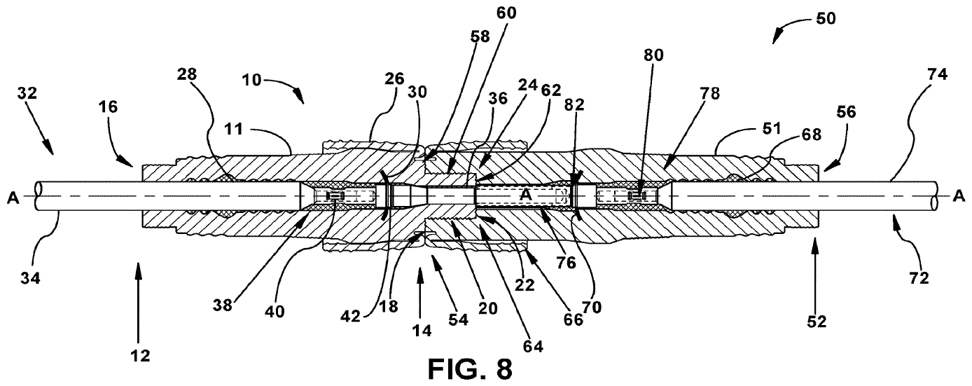

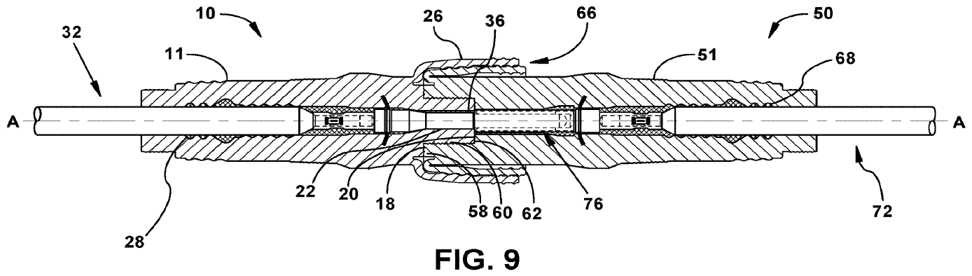

In an example embodiment one of the first vertical surface 18, receptacle horizontal surface 20, and second receptacle vertical surface 22 comprise at least one rib 59. The at least one rib 59 provide a seal with a plug (not shown, see e.g., FIGS. 8, 9, infra) when the receptacle 50 is coupled with the receptacle. In an example embodiment, the first receptacle vertical surface 58 comprises at least one rib 59. In another example embodiment the receptacle horizontal surface 60 comprises at least one rib 59. In yet another example embodiment, the second receptacle vertical surface 62 comprises at least one rib 59.

In an example embodiment, two of the surfaces selected from the first receptacle vertical surface 58, the receptacle horizontal surface 60, and the second receptacle vertical surface 62 comprise at least one rib 59. For example, in one embodiment, the first receptacle vertical surface 58 and the receptacle horizontal surface 60, comprise at least one rib 59. As another example, the receptacle horizontal surface 60, and the second receptacle vertical surface 62 comprise at least one rib 59. In yet another example, the first receptacle vertical surface 58, and the second receptacle vertical surface 62 comprise at least one rib 59. In still yet another example embodiment, he first receptacle vertical surface 58, the receptacle horizontal surface 60, and the second receptacle vertical surface 62 have ribbed surfaces.

The flap 66 when extended outward as illustrated in FIG. 5 has a length sufficient to extend over a designed ridge on a plug to form a watertight seal preventing water from reaching the pin contact assembly (not shown, see e.g., FIGS. 3,4) and/or the socket contact assembly (not shown, see e.g., FIGS. 6,7).

In an example embodiment, the receptacle housing 51 further comprises a cable ribbed seal 68 near the first end 52 of the receptacle housing 50. The cable ribbed seal 68 comprises at least one rib and is employed to seal the pin connector from water or other contaminants entering through the first end 52.

In an example embodiment, the receptacle housing 51 comprises a lock washer 70 that is molded into the housing. As will be described herein infra, the lock washer 70 can be employed to engage and hold a conductor.

In particular embodiments, the flap 66 comprises at least one rib 69 which can form a seal when the flaps 66 are extended when the receptacle 50 is coupled with a plug. When the receptacle 50 is coupled with a plug the surface of the plug that abut surfaces 58 can be either smooth or ribbed, the surface of the plug that abuts surface 60 can either be smooth or ribbed, and the surface of the plug that abuts surface 62 can either be smooth or ribbed.

In an example embodiment, the first end 52 of the housing 51 has a first surface 13 and a second surface 15. The first surface 15 and second surface 17 are separated by a vertical surface 17.

FIG. 6 illustrates an example of a cable 72 with a socket contact assembly 76 attached thereto that is suitable for use with the receptacle illustrated in FIG. 5, which is illustrated in FIG. 7. The cable 72 comprises insulation 74 that passes through bore 56. The end 78 of the cable 72 where the socket contact assembly 76 is attached is stripped of insulation 74. A crimp connection 80 is employed to mount the socket contact assembly 76 onto the stripped end 78 of the cable 72. As will be described herein infra, the socket contact assembly 76 comprises a lock ring 82 configured to engage the lock washer 70 of the receptacle housing 51.

FIG. 7 illustrates an example of a cutaway view of the receptacle housing 51 as illustrated in FIG. 5 attached to the cable illustrated in FIG. 6. The cable ribbed seal 68 engages the insulation 74 of cable 72 and forms a barrier against water or other contaminants. The lock washer 70 engages the lock ring 82 to hold the receptacle housing 51 onto the cable 72. Surfaces 58, 60, and 62 abut surfaces of a plug and prevent water and other contaminants from reaching the socket contact assembly 76. As described herein, supra, one or more of surfaces 58, 60, and 62 are ribbed.

FIG. 8 illustrates an example cutaway view of the plug 10 coupled with the receptacle 50. In the illustrated example, both flap 26 (the first flap) and flap 66 (the second flap) are in the folded position. The plug has a first cable 32 coupled with a pin contact assembly 36. The receptacle has a second cable 52 coupled with a socket contact assembly 76. When the plug 10 is plugged into the receptacle 50, or the plug 10 is coupled with the receptacle 50, the pin contact assembly 36 contacts the socket contact assembly 76 forming an electrical connection between the first cable 32 and the second cable 52.

In the illustrated example, the first plug vertical surface 18, the plug horizontal surface 20, the second plug vertical surface 22, the first receptacle vertical surface 58, the receptacle horizontal surface 60, and second receptacle vertical surface 62 comprise at least one rib 59. However, as those skilled in the art can readily appreciate, other embodiments can have any one or more of the first plug vertical surface 18, the plug horizontal surface 20, the second plug vertical surface 22, the first receptacle vertical surface 58, the receptacle horizontal surface 60, and second receptacle vertical surface 62 comprises at least one rib 59. In some embodiments, one or more of the first plug vertical surface 18, the plug horizontal surface 20, the second plug vertical surface 22 have ribs. In other embodiments, one or more of the first receptacle vertical surface 58, the receptacle horizontal surface 60, and second receptacle vertical surface 62 have ribs. In still other embodiments, one or more of the first plug vertical surface 18, the plug horizontal surface 20, the second plug vertical surface 22 have ribs, and one or more of the first receptacle vertical surface 58, the receptacle horizontal surface 60, and second receptacle vertical surface 62 have ribs.

FIG. 9 illustrates an example cutaway view of a plug 10 coupled with a receptacle 50 with the flaps 26, 66 engaged. In the illustrated example, flap 26 is extended (or in the unfolded position) and engages flap 66 which is folded. Flap 26 when extended outward as illustrated in FIGS. 1 and 9 has a length sufficient to extend over a designed ridge on flap 66 of the receptacle 50 to form a waterproof seal preventing water from reaching the pin contact assembly 36 and/or the socket contact assembly 76. However, as those skilled in the art can readily appreciate, in some embodiments, flap 66 is extended (or in the unfolded position) and engages flap 26 which would be folded. Flap 66 when extended outward as illustrated in FIGS. 5 and 9 has a length sufficient to extend over a designed ridge on flap 26 of the plug 10 to form a waterproof seal preventing water from reaching the pin contact assembly 36 and/or the socket contact assembly 76.

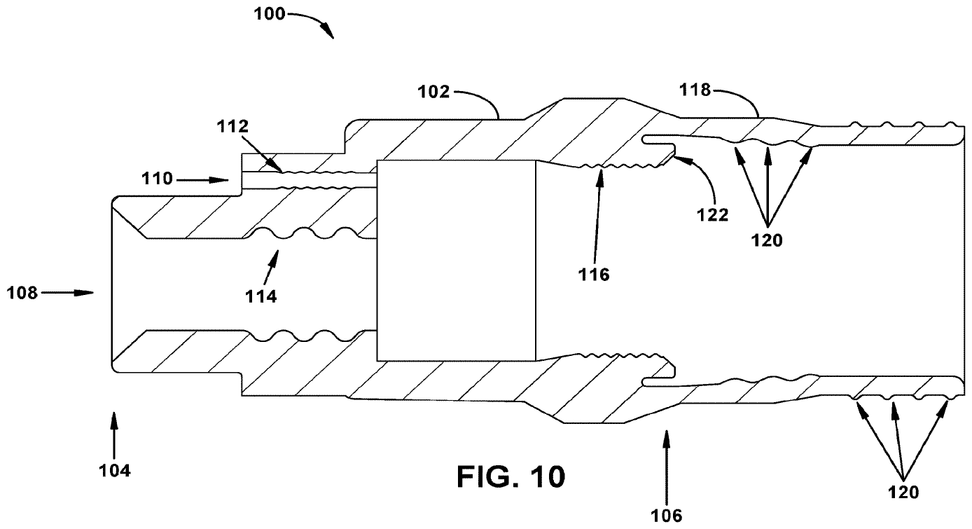

FIG. 10 illustrates an example cutaway view of a cable shield boot housing 100. In the examples illustrated herein, the cable shield boot housing 100 is substantially cylindrical but those skilled in the art can readily appreciate that the principles described herein are adaptable to other three dimensional shapes so the example embodiments described herein should not be construed as limited to cylindrical structures.

The cable shield boot housing 100 comprises a housing 102 with first 104 and second 106 ends. At the first end 104 of the housing 102 is a cable port 108. Also, near the first end 104 is a cable shield connector port 110. A shield ribbed seal 112 that comprises at least one rib is located in the shield connector port 110. the shield ribbed seal 112 comprises at least one rib for abutting and forming a seal with a shield connector as will be shown and described herein infra. A cable ribbed seal 114 that comprises at least one rib is located in the cable port 108. A ribbed housing seal 116 that comprises at least one rib is located at the second end 106 of the housing 102. A flap 118, which is illustrated in an extended position is coupled with the second end 106 of the housing 102. In particular embodiments, the flap 118 has one or more ribs 120. In particular embodiments, the housing 102 further comprises a surface 122 whose function will be shown and described herein infra. Although the illustrated example shows a small gap between an edge or surface 122 and the second end 106, those skilled in the art can readily appreciate that in other embodiments there is no gap and surface 122 connects to the second end 106 of the housing 102.

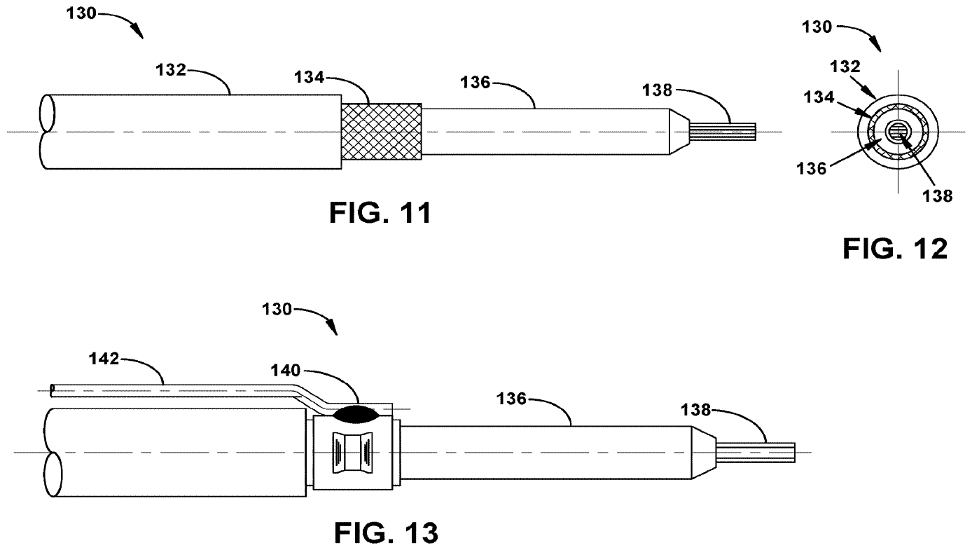

FIG. 11 illustrates an example of a shielded cable suitable 130 for use with the cable shield boot housing 100 described in FIG. 10. FIG. 12 illustrates an example of a cross sectional view of the shielded cable 130 described in FIG. 11. The shielded cable 130 comprises a cable jacket 132. Underneath the cable jacket is a shield cable 134. Underneath the shield cable 134 is a conductor insulator 136. Underneath the conductor insulator 136 is a conductor. As those skilled in the art can readily appreciate, removal of a portion of the cable jacket 132 exposes the cable shield 134. Removal of a portion of the exposed cable shield 134 exposes the cable insulator 136. Removal of the cable insulator 136 exposes the conductor 138.

In an example embodiment, the cable ribbed seal is configured to form a seal with the cable 130 when the cable is positioned so that the cable jacket 132 abuts the cable ribbed seal 114. The conductor insulator 136 and conductor 138 extend from the second end 106 of the cable shield boot housing 100.

FIG. 13 illustrates an example of a the shielded cable 130 described in FIGS. 11 and 12 coupled with a shield ring 140 hat is coupled with a shield conductor 142. The shield ring 140 is in contact with the outer conductor 134 of the shielded conductor 130.

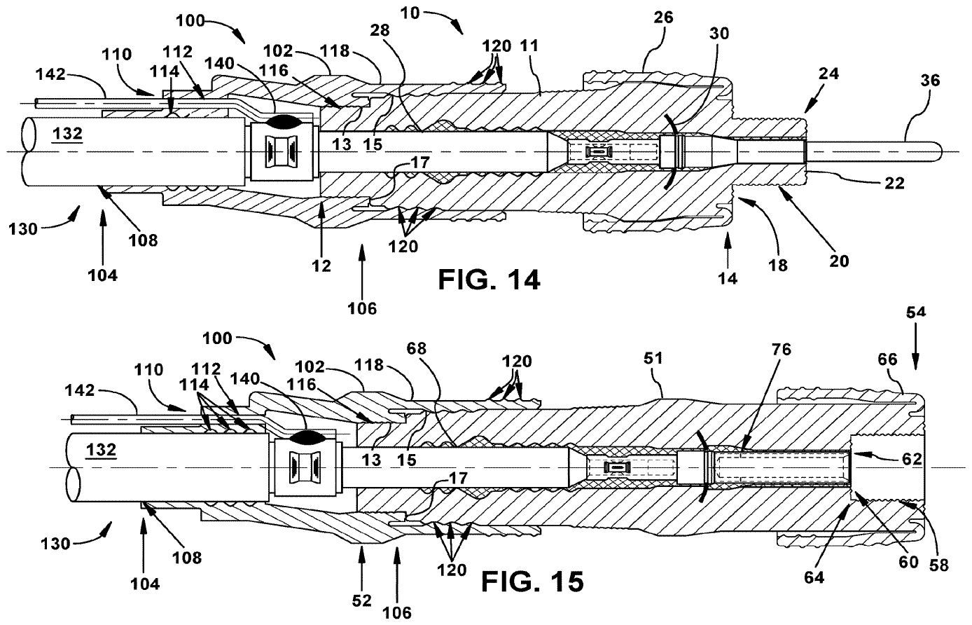

FIG. 14 illustrates an example of a plug 10 coupled with a shielded cable 130 and a cable shielded boot housing 100. The cable 130 extends through the cable port 108 through the housing 102 of the cable shield boot housing 100 and from the second end 106 of the housing 102 into the first (also known as the boot) end 12 of the plug housing 11 and through the plug housing 11 and extending beyond the second end 14 of the plug housing 11.

In an example embodiment, when the cable 130 is positioned within the housing 102 of the cable shield boot housing 100 and the plug housing 11 of plug 10, the cable ribbed seal 114 in the cable port 108 is configured to abut and form a seal; with the cable jacket 132. The shield ribbed seal 112 is configured to abut and form a seal with the shield conductor 142. The conductor insulator 136 and conductor 138 extend from the second end 106 of the housing 102.

In an example embodiment, the ribbed housing seal 116 is configured to abut and form a seal with a first surface 13 of the plug (or connector) housing 11. The 118 flap comprises at least one rib 120 configured to abut and form a seal with a second surface 15 of the plug housing 11 when the flap 118 is in an extended position. In particular embodiments, the flap 118 is configured to move between an extended and folded (not shown) position.

In particular embodiments, a vertical surface 17 is disposed between the first surface 13 and the second surface 17. The vertical surface 17 abuts with a corresponding vertical surface 122 on the housing 102 of the cable shield boot housing 100 when the cable shield boot housing 100 is mounted onto the plug housing 11.

In an example embodiment, the plug connector housing 11 comprises a cable ribbed seal 28. The cable ribbed seal 28 configured to abut and form a seal with the conductor insulation 136 of the cable 138.

In an example embodiment, the conductor 138 is coupled with a pin connector assembly 36. Any suitable type of connection can be employed for attaching the pin connector assembly 36 to the conductor 138, such as, for example, a crimped connection.

FIG. 15 illustrates an example of a receptacle 50 coupled with a shielded cable 130 and a shielded boot housing 100. The cable 130 extends through the cable port 108 through the housing 102 of the cable shield boot housing 100 and from the second end 106 of the housing 102 into the first (also known as the boot) end 52 of the receptacle housing 51 and through the receptacle housing 51 and extending beyond the second end 54 of the receptacle housing 51.

In an example embodiment, when the cable 130 is positioned within the housing 102 of the cable shield boot housing 100 and the receptacle housing 51 of receptacle 50, the cable ribbed seal 114 in the cable port 108 is configured to abut and form a seal; with the cable jacket 132. The shield ribbed seal 112 is configured to abut and form a seal with the shield conductor 142. The conductor insulator 136 and conductor 138 extend from the second end 106 of the housing 102.

In an example embodiment, the ribbed housing seal 116 is configured to abut and form a seal with a first surface 13 of the receptacle (or connector) housing 51. The 118 flap comprises at least one rib 120 configured to abut and form a seal with a second surface 15 of the receptacle housing 51 when the flap 118 is in an extended position. In particular embodiments, the flap 118 is configured to move between an extended and folded (not shown) position.

In particular embodiments, a vertical surface 17 is disposed between the first surface 13 and the second surface 17. The vertical surface 17 abuts with a corresponding vertical surface 122 on the housing 102 of the cable shield boot housing 100 when the cable shield boot housing 100 is mounted onto the receptacle housing 51.

In an example embodiment, the cable connector housing 51 comprises a cable ribbed seal 68. The cable ribbed seal 68 is configured to abut and form a seal with the conductor insulation 136 of the cable 130.

In an example embodiment, the conductor 138 is coupled with a socket connector assembly 76. Any suitable type of connection can be employed for attaching the socket connector assembly 76 to the conductor 138, such as, for example, a crimped connection.

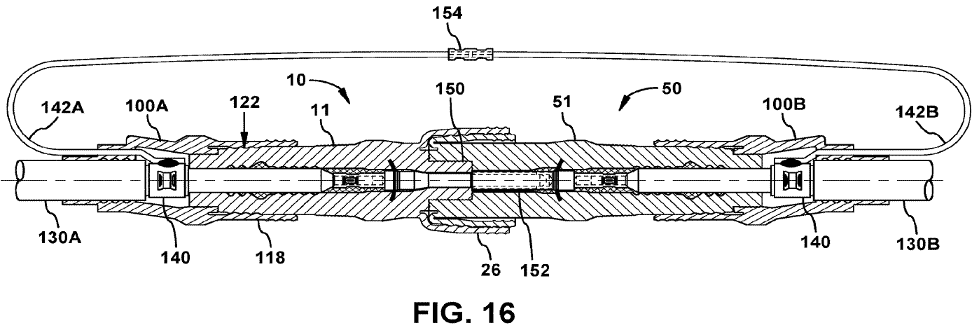

FIG. 16 illustrates an example cutaway view of a plug 11 coupled with a receptacle 150 for a shielded cable 130 with shielded boot housings 100. The interface 150 represents where surfaces 18, 20, 22 abut surfaces 58, 60, 62 respectively. A first cable 130A is coupled with the cable shield boot housing 100A that is coupled with plug 10. A second cable 130B is coupled with the cable shield boot housing 100B that is coupled with receptacle 50. The connection of the pin connector assembly with the socket connector assembly is represented by 152. The connection 154 is the connection of the shield conductor 142A coupled with the cable 130A to the shield conductor 142B that is coupled with the cable 130B.

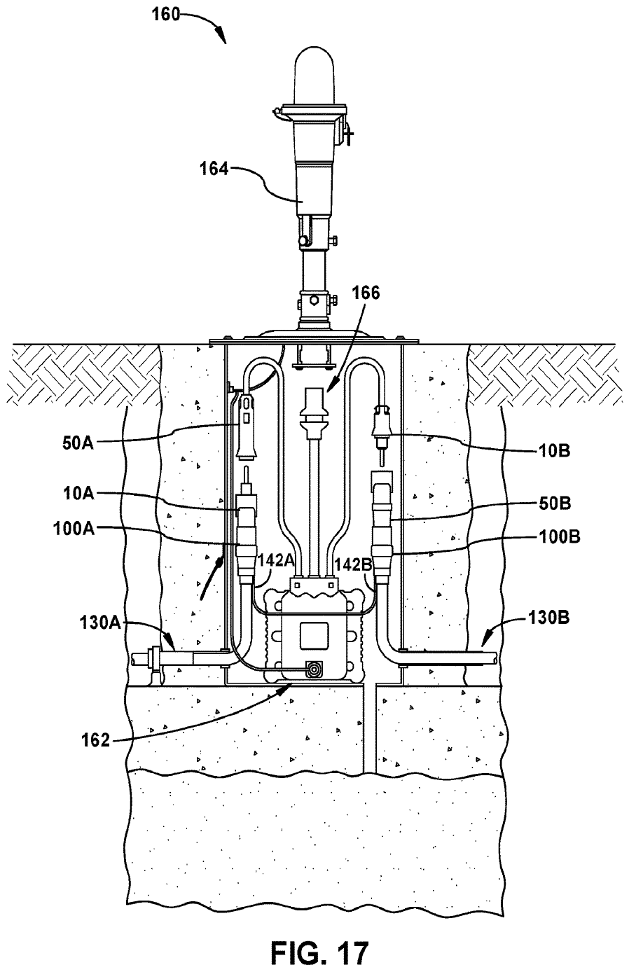

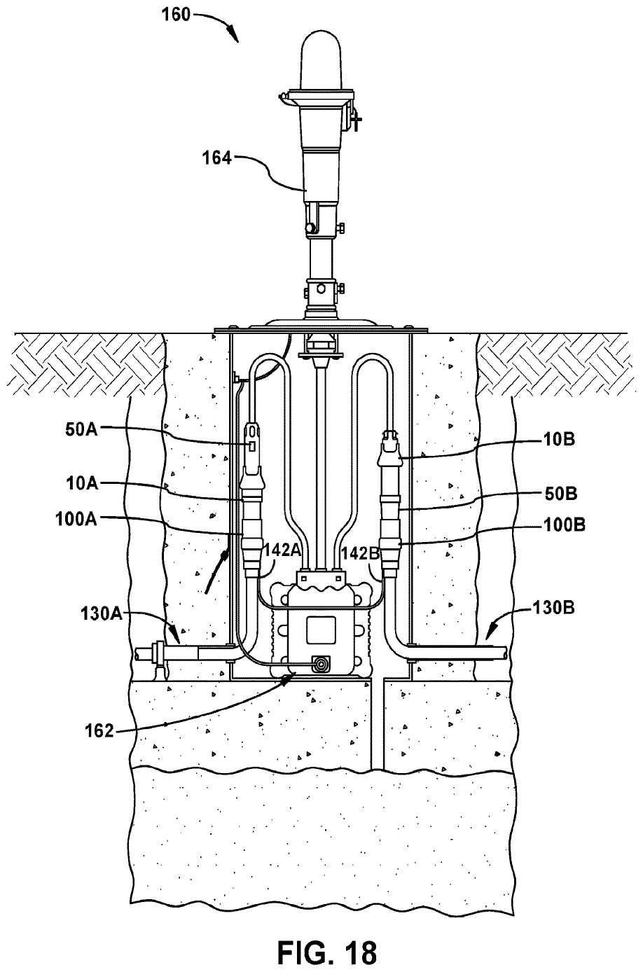

FIG. 17 illustrates an example cutaway view of an airfield light system 160 that employs an isolation transformer 162 that is coupled with shielded cables 130A, 130B and an airfield luminaire 164 with the plugs 10A, 10B and receptacles 50A, 50B unplugged. In an example embodiment, the cables 130A and 130B are shielded cables coupled with the isolation transformer's 162 primary coil (not shown). Connector 166 is coupled with the isolation transformer's 162 secondary coil (not shown) and provides power to the airfield luminaire 164. FIG. 18 illustrates an example cutaway view of an airfield light system 160 that employs an isolation transformer 162 that is coupled with shielded cables 130A, 130B and an airfield luminaire 164 with the plugs 10A, 10B and receptacles 50A, 50B attached.

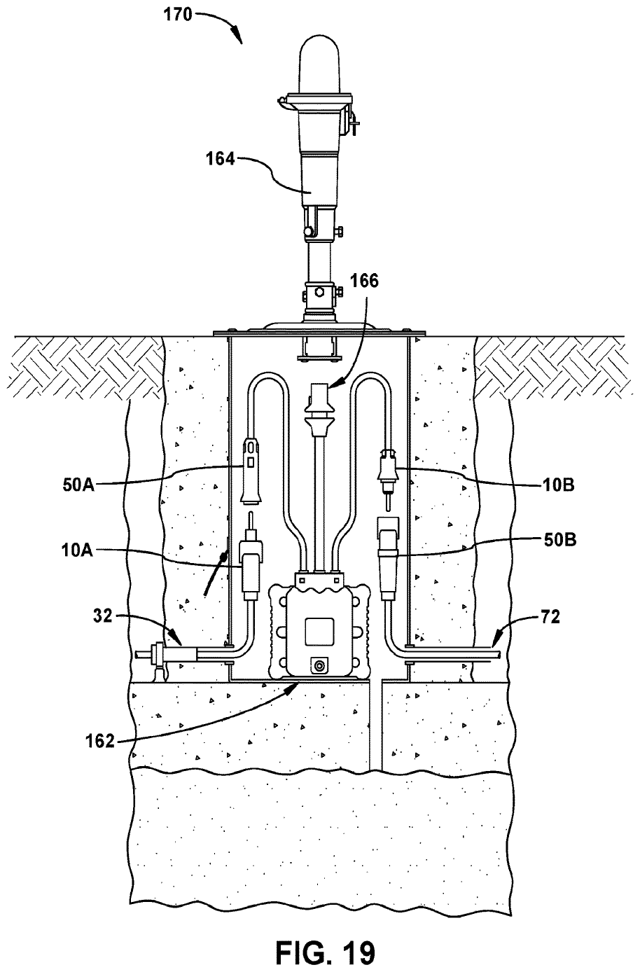

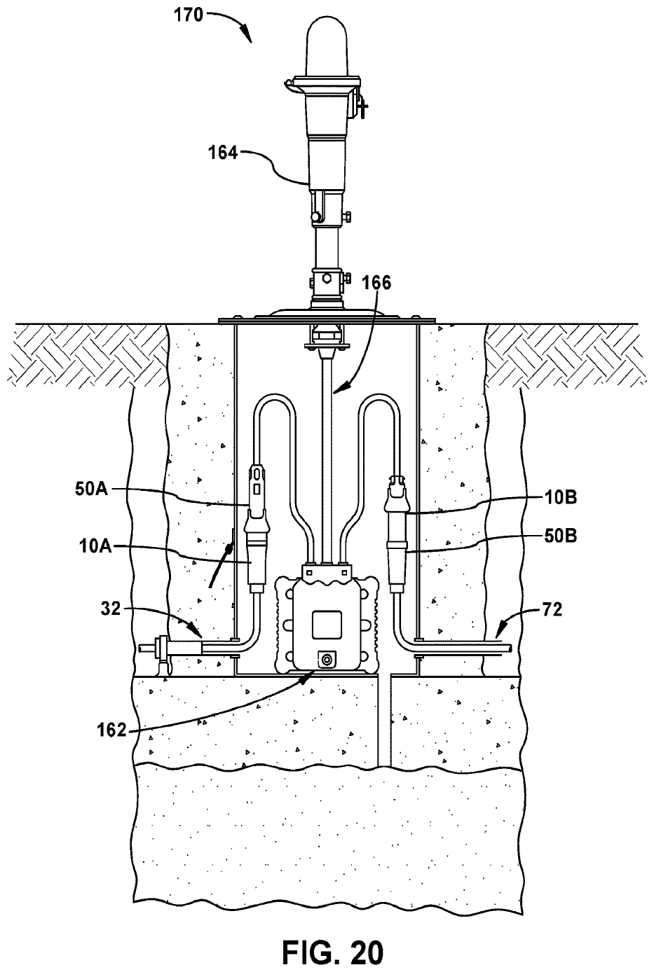

FIG. 19 illustrates an example cutaway view of an airfield light system 170 that employs an isolation transformer 162 that is coupled with unshielded cables 32, 72 and an airfield luminaire 164 with the plugs and receptacles unattached. FIG. 20 illustrates an example cutaway view of an airfield light system 170 that employs an isolation transformer 162 that is coupled with unshielded cables 32, 72 and an airfield luminaire 164 with the plugs and receptacles attached.

Although the illustrated examples show one pin contact assembly and one socket contact assembly, those skilled in the art can readily appreciate that this was selected merely for ease of illustration. The principles described in the example embodiments herein can be applied to plugs having any physically realizable number of pin assemblies and receptacles with any physically realizable number of socket assemblies, therefore, the example embodiments described herein should not be construed as limited to plugs with a single pin contact assembly and/or a socket with a single socket contact assembly.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally and equitably entitled.

1. A plug, comprising:
a plug housing that comprises a first end and a second end;
the first end comprises a bore configured to receive a cable;
the second end having a first plug vertical surface, a plug horizontal surface extending from the first plug vertical surface, and a second plug vertical surface extending from an opposite end of the plug horizontal surface;
wherein the first plug vertical surface, plug horizontal surface, and second plug vertical surface are configured to be coupled with a receptacle; and
wherein a surface selected from the group consisting of the first plug vertical surface, the plug horizontal surface, and the second plug vertical surface comprise a rat least one rib.

2. The plug set forth in claim 1, wherein two surfaces selected from the group consisting of the first plug vertical surface, the plug horizontal surface, and the second plug vertical surface comprises at least one ribs.

3. The plug set forth in claim 2, wherein the first plug vertical surface, the plug horizontal surface, and the second plug vertical surface comprises at least one rib.

4. The plug set forth in claim 3, wherein a cable is received through the bore at the first end and a pin extends from the opposite end of the plug horizontal surface.

5. The plug set forth in claim 4, further comprising:
a lock washer molded into the plug housing;
the pin further comprises a lock ring; and
wherein the lock washer engages the lock ring and prevents movement of the cable within the plug housing.

6. The plug set forth in claim 5, the plug housing further comprises a cable ribbed seal positioned near the first end of the plug housing.

7. The plug set forth in claim 6, the plug housing further comprises a flap that moves between a folded and extended position, wherein when the flap forms a seal with an associated receptacle when the plug is coupled with the associated receptacle and the flap is in the extended position.

8. A receptacle, comprising:
a receptacle housing that comprises a first end and a second end;
the first end comprises a bore configured to receive a cable;
the second end having a first receptacle vertical surface, a receptacle horizontal surface extending into the receptacle housing from the first receptacle vertical surface, and a second receptacle vertical surface extending from an opposite end of the receptacle horizontal surface;
wherein the first receptacle vertical surface, receptacle horizontal surface, and second receptacle vertical surface are configured to be coupled with a receptacle; and
wherein a surface selected from the group consisting of the first receptacle vertical surface, the receptacle horizontal surface, and the second receptacle vertical surface comprise at least one rib.

9. The receptacle set forth in claim 8, wherein two surfaces selected from the group consisting of the first receptacle vertical surface, the receptacle horizontal surface, and the second receptacle vertical surface comprises at least one rib.

10. The receptacle set forth in claim 9, wherein the first receptacle vertical surface, the receptacle horizontal surface, and the second receptacle vertical surface comprises at least one rib.

11. The receptacle set forth in claim 10, wherein a cable is received through the bore at the first end and a socket contact extends from the opposite end of the receptacle horizontal surface.

12. The receptacle set forth in claim 11, further comprising:
a lock washer molded into the receptacle housing;
the socket contact further comprises a lock ring; and
wherein the lock washer engages the lock ring and prevents movement of the cable within the receptacle housing.

13. The receptacle set forth in claim 12, the receptacle housing further comprises a cable ribbed seal positioned near the first end of the receptacle housing.

14. The receptacle set forth in claim 13, the receptacle housing further comprises a flap that moves between a folded and extended positions, wherein when the flap forms seal with an associated plug when the receptacle is coupled with the associated plug the flap is in the extended position.

15. A cable shield boot housing, comprising:
a housing with first and second ends;
a cable port at a first end of the housing;
a flap extending from the second end of the housing;
a shield connector port located near the first end of the housing;
a shield ribbed seal located in the shield connector port;
a cable ribbed seal located in the cable port; and
a ribbed housing seal located at the second end of the housing.

16. The cable shield boot housing set forth in claim 15, wherein a cable that comprises a cable jacket, cable shield, conductor insulation, and conductor extends from the cable port to the second end of the housing, where the cable ribbed seal is configured to abut and form a seal; with the cable jacket, the shield ribbed seal is configured to abut and form a seal with the shield conductor, and the conductor insulator and conductor extend from the second end of the cable shield boot housing.

17. The cable shield boot housing set forth in claim 16, the ribbed housing seal is configured to abut and form a seal with a first surface of a connector housing.

18. The cable shield boot housing set forth in claim 17, the flap comprises at least one rib configured to abut and form a seal with a second surface of the connector housing.

19. The cable shield boot housing set forth in claim 18, the connector housing comprises a cable ribbed seal configured to abut and form a seal with the conductor insulation of the cable.

20. The cable shield boot housing set forth in claim 16, further comprising a connector assembly coupled with the conductor, the connector assembly is selected from the group consisting of a pin connector assembly coupled with the conductor and a socket connector assembly.
